(19) United States
(12) Patent Application Publication
(10) Pub. No.: US 2026/0276547 A1
(43) Pub. Date: Sep. 17, 2026

(54) FLUORESCENCE MICROSCOPE

(71) Applicant: Keyence Corporation, Osaka (JP)

(72) Inventor: Ryutaro HIRABAYASHI, Osaka (JP)

(73) Assignee: Keyence Corporation, Osaka (JP)

(21) Appl. No.: 19/531,744

(22) Filed: Feb. 6, 2026

(30) Foreign Application Priority Data
Mar. 13, 2025 (JP) 2025-039929

(51) Int. Cl. G01N 21/64; G02B 21/06; G02B 21/16; G02B 21/26

(52) U.S. Cl. CPC G01N 21/6458; G02B 21/06; G02B 21/16; G02B 21/26

(57) ABSTRACT

To suppress an increase in size of a housing even when the number of filter cubes is increased. A fluorescence microscope includes: an optical module that is disposed on an optical path of excitation light emitted from an illumination module, collects the excitation light emitted from the illumination module, guides the excitation light to an observation target, and collects fluorescence generated in the observation target; a Z-plate that is connected to the optical module and includes a protrusion extending rearward of the optical module; and a Z-drive module that is connected to the protrusion of the Z-plate and moves the optical module in a Z direction.

### CROSS-REFERENCE TO RELATED APPLICATIONS

The present application claims foreign priority based on Japanese Patent Application No. 2025-039929, filed Mar. 13, 2025, the contents of which are incorporated herein by reference.

### BACKGROUND OF THE INVENTION

### 1. TECHNICAL FIELD

The present disclosure relates to a fluorescence microscope.

### 2. DESCRIPTION OF THE RELATED ART

For example, in a fluorescence microscope disclosed in JP2015-84063A, excitation light with which an observation target is irradiated and fluorescence generated in the observation target are separated by a filter cube, and the fluorescence is detected, thereby enabling fluorescence observation of the observation target.

In the fluorescence observation, a plurality of kinds of fluorescent reagents is used, and the wavelengths of excitation light and fluorescence differ depending on the fluorescent reagents. In order to cope with this, in JP2015-84063A, four filter cubes are attached to a filter turret, and at the time of observation, the filter turret is rotated so that the filter cube corresponding to the used fluorescent reagent is disposed on an observation optical path.

The filter turret is accommodated in a housing.

Meanwhile, since an optical module that collects the fluorescence generated in the observation target needs to be moved in a Z direction at the time of focusing, for example, a Z-drive module for driving the optical module in the Z direction is also accommodated in the housing together with the filter turret.

Here, since there are many kinds of fluorescent reagents, there is a case where it is desired to increase the number of filter cubes to be larger than that in JP2015-84063A in order to be able to cope with observation using more fluorescent reagents. When the number of filter cubes is increased, an outer diameter of the filter turret is increased. Therefore, there is a possibility that the filter turret and the Z-drive module interfere with each other. To avoid this, the housing is increased in size, and a space required for installing the fluorescence microscope is increased.

### SUMMARY OF THE INVENTION

The present disclosure has been made in view of such a point, and an object thereof is to suppress an increase in size of a housing even when the number of filter cubes is increased.

According to one embodiment of the present disclosure, in order to achieve the above object, a fluorescence microscope includes: a stage on which an observation target is placed; an illumination module configured to irradiate the observation target placed on the stage with excitation light; an optical module disposed on an optical path of the excitation light emitted from the illumination module, and configured to collect the excitation light emitted from the illumination module and guide the excitation light to the observation target, and collect fluorescence generated in the observation target; an imaging module disposed on an optical path of the fluorescence collected by the optical module and configured to detect the fluorescence collected by the optical module; a Z-plate connected to the optical module and including a protrusion extending rearward of the optical module; a Z-drive module connected to the protrusion of the Z-plate and configured to move the optical module in a Z direction; a base housing configured to accommodate the stage, the illumination module, the optical module, the imaging module, and the Z-drive module; and an upper surface lid connected to the base housing and configured to open and close an opening formed in an upper portion of the base housing.

According to this configuration, for example, at the time of focusing, the optical module is moved in the Z direction by the Z-drive module via the Z-plate. At this time, the Z-plate includes the protrusion extending rearward of the optical module, and the protrusion is connected to the Z-drive module, so that the Z-drive module can be disposed rearward. Therefore, even if the number of filter cubes is increased and the outer diameter of the filter turret is increased, the Z-drive module can be disposed to be retracted from the side of the filter turret, and thus, an increase in size of the housing is suppressed.

The fluorescence microscope may further include a support portion configured to support the Z-plate and guide movement of the optical module in the Z direction. That is, it is possible to improve, by the support portion, the vibration resistance of the stage which is likely to be lowered by disposing the Z-drive module on a rear side.

Furthermore, according to another embodiment of the present disclosure, it can be based on a fluorescence microscope that enables fluorescence observation of an observation target by separating excitation light with which the observation target is irradiated and fluorescence generated in the observation target by a filter cube and detecting the fluorescence.

A fluorescence microscope may also have a configuration including: a stage on which an observation target is placed and that is movable in XY directions; an illumination module that irradiates the observation target placed on the stage with excitation light; a plurality of objective lenses that is disposed below the stage and collects fluorescence generated from the observation target by being irradiated with the excitation light from the illumination module; a revolver in which the plurality of objective lenses is rotatably disposed about a first rotation shaft extending in a vertical direction and that switches the objective lenses disposed on an observation optical path; a plurality of absorption filters that is disposed below the revolver and selectively transmits a predetermined wavelength band; a turret in which the plurality of absorption filters is rotatably disposed about a second rotation shaft extending in the vertical direction and that switches the absorption filters disposed on the observation optical path; a light receiving section that receives fluorescence that is generated in the observation target and passes through the objective lenses and absorption filters disposed on the observation optical path; a Z-plate that is connected to the revolver and includes a protrusion extending rearward of the revolver; and a Z-drive module that is connected to the protrusion of the Z-plate and moves the revolver in a Z direction.

As described above, since the Z-plate including the protrusion extending rearward of the optical module is provided and the Z-drive module is connected to the protrusion of the Z-plate, it is possible to suppress an increase in size of a housing even if the number of filter cubes is increased.

### BRIEF DESCRIPTION OF THE DRAWINGS

FIG. 1 is a diagram illustrating a configuration of a fluorescence microscope according to an embodiment of the present invention;

FIG. 2 is a diagram describing an internal structure of a microscope body and a light source unit;

FIG. 3 is a schematic diagram illustrating an optical path of the fluorescence microscope;

FIG. 4 is a perspective view of a microscope body in which a base housing, a transmitted illumination section, a stage frame, an upper frame, and the like are omitted;

FIG. 5 is a diagram of the microscope body illustrated in FIG. 4 as viewed from front;

FIG. 6 is a cross-sectional view of a filter unit and an emission filter unit;

FIG. 7 is a plan view of the filter unit;

FIG. 8 is a perspective view of the filter unit and the emission filter unit as viewed from above;

FIG. 9 is an enlarged perspective view of a filter cube attached to a filter turret as viewed from above;

FIG. 10 is a perspective view of a single filter cube as viewed from above;

FIG. 11 is a perspective view of the single filter cube as viewed from below; and

FIG. 12 is a perspective view of the emission filter unit as viewed from above.

### DETAILED DESCRIPTION

Hereinafter, embodiments of the present invention will be described in detail with reference to the drawings. Note that the following description of preferred embodiments is merely exemplary in nature and is not intended to limit the present invention, its application, or its use. For example, the relative size and positional relationship of each member illustrated in the drawings are for describing one embodiment, and do not limit the present invention.

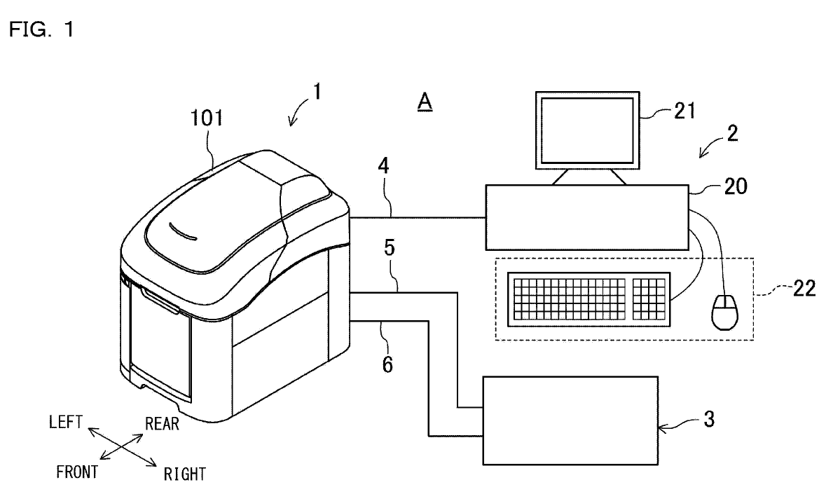

FIG. 1 is a diagram illustrating a configuration of a fluorescence microscope A according to an embodiment of the present invention. The fluorescence microscope A can perform fluorescence observation of an observation target. Furthermore, in addition to the fluorescence observation, the fluorescence microscope A can perform bright field observation, dark field observation, phase difference observation, differential interference observation, and the like using light transmitted through the observation target. In the following description, the bright field observation, the dark field observation, the phase difference observation, and the differential interference observation using light transmitted through the observation target are collectively referred to as transmission observation.

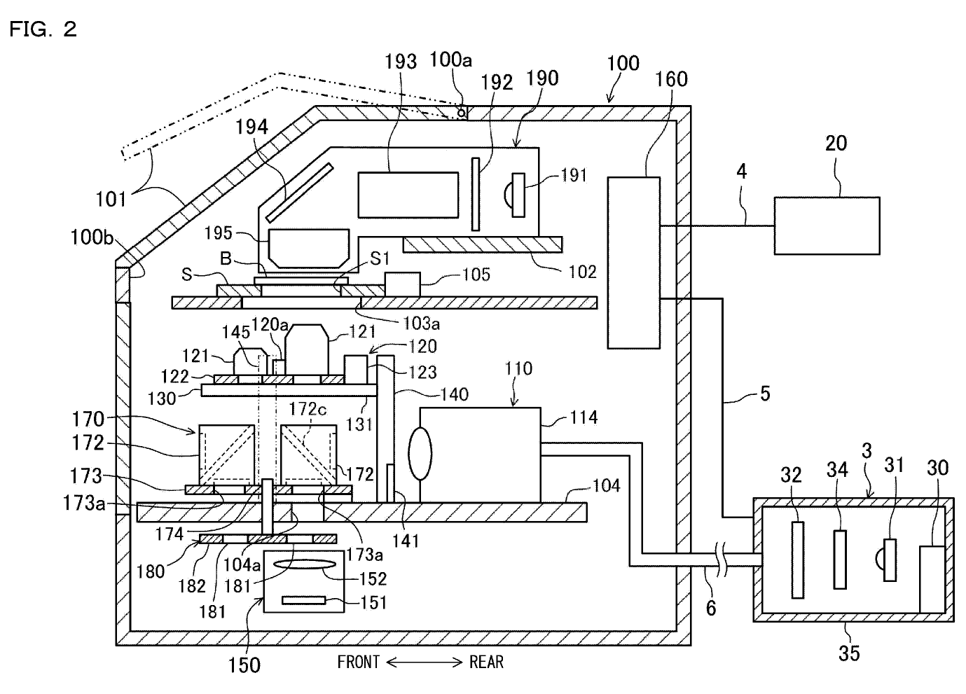

The observation target B (schematically illustrated in FIG. 2) observed in the present embodiment is a biological specimen or the like including various proteins. In a case where fluorescence observation of a biological specimen is performed, a fluorescent reagent that binds to a specific protein is used for the observation target B. Examples of the fluorescent reagent include green fluorescent protein (GFP), TexasRed, and diamidinophenylindole (DAPI), but fluorescence observation using a fluorescent reagent other than these is also possible.

For example, the GFP absorbs light having a wavelength of around 490 nm and emits light having a wavelength of around 510 nm. The TexasRed absorbs light having a wavelength of around 596 nm and emits light having a wavelength of around 620 nm. The DAPI absorbs light having a wavelength of around 345 nm and emits light having a wavelength of around 455 nm. As described above, the wavelength of light absorbed by the fluorescent reagent is different, and the wavelength of light emitted is also different.

The fluorescence microscope A includes, for example, a microscope body 1, an electronic computer 2, and a light source unit 3. Therefore, the fluorescence microscope A can also be referred to as a fluorescence microscope system or a fluorescence microscope device. The microscope body 1 and the electronic computer 2 are connected by a first wiring 4 and can communicate with each other. The microscope body 1 and the light source unit 3 are connected by a second wiring 5 and can communicate with each other. Moreover, the microscope body 1 and the light source unit 3 are connected by a fiber cable (transmission member) 6, and excitation light generated by the light source unit 3 can be transmitted to the microscope body 1 via the fiber cable 6 as described later. As described above, the fluorescence microscope A also includes the first wiring 4, the second wiring 5, and the fiber cable 6. As the first wiring 4, for example, a local area network (LAN) cable, a universal serial bus (USB) cable, or the like can be used. As the second wiring 5, for example, a cable in which a power supply line and a signal line are integrated can be used.

Note that the electronic computer 2 may be omitted, and the function of the electronic computer 2 may be incorporated in the microscope body 1. Furthermore, the light source unit 3 may be omitted, and the function of the light source unit 3 may be incorporated in the microscope body 1. Furthermore, the microscope body 1 may be configured by a single device.

As illustrated in FIG. 2, the light source unit 3 includes a power supply device 30, an illumination section 31, an excitation filter 32 that selectively transmits a wavelength of excitation light emitted from the illumination section 31, a light shielding mechanism 34, and an illumination housing 35. The power supply device 30, the illumination section 31, the excitation filter 32, and the light shielding mechanism 34 are accommodated in the illumination housing 35. A commercial power supply is connected to the power supply device 30, and power is supplied from the commercial power supply. The power supply device 30 supplies power supplied from the commercial power supply to the illumination section 31 and also supplies the power to the microscope body 1 via the second wiring 5. A power supply mode is not limited to the above-described mode, and the commercial power supply may be connected to the microscope body 1.

The illumination section 31 is a part that generates light used for observation, and includes, for example, a white light emitting diode (LED) or the like. The illumination section 31 may be configured with a light source other than a white light emitting diode (LED), and may be, for example, another light source such as a metal halide lamp, a mercury lamp, or a xenon lamp. The light emitted from the illumination section 31 is excitation light used at the time of fluorescence observation.

The light shielding mechanism 34 is, for example, a mechanical shutter. The light shielding mechanism 34 is disposed so as to be located on an optical path of light emitted from the illumination section 31. In a case where the light shielding mechanism 34 is in the non-light shielding state, the light emitted from the illumination section 31 passes through the light shielding mechanism 34 and enters the excitation filter 32. On the other hand, in a case where the light shielding mechanism 34 is in a light shielding state, the light emitted from the illumination section 31 is blocked and is not incident on the excitation filter 32. The light shielding mechanism 34 may include a light modulation element capable of switching between passage and blocking of light emitted from the illumination section 31. The light shielding mechanism 34 is in a non-light shielding state in a case where fluorescence observation of the observation target B is performed, and is in a light shielding state in a case where fluorescence observation of the observation target B is not performed.

The excitation filter 32 includes a plurality of excitation filters corresponding to the types of fluorescent reagents. When the light emitted from the illumination section 31 enters the excitation filter 32, the wavelength of the excitation light is selectively transmitted and emitted to one end portion of the fiber cable 6. The excitation light incident on one end portion of the fiber cable 6 is transmitted to the other end portion of the fiber cable 6 and is incident on the microscope body 1. The fiber cable 6 may be either a glass fiber or a quartz fiber. Furthermore, a liquid light guide or the like can also be used as the transmission member. Since the light source unit 3 is separated from the microscope body 1 in this manner, it is not necessary to provide the illumination section 31 that easily generates heat in the microscope body 1. Therefore, a countermeasure for heat dissipation of the microscope body 1 becomes unnecessary, and it is possible to achieve both irradiation of strong excitation light and miniaturization of the microscope body 1.

The microscope body 1 includes a base housing 100. Since the base housing 100 is separated from the illumination housing 35, it can be installed separately from the illumination housing 35. In the description of this embodiment, as illustrated in a front-rear direction and a left-right direction in FIG. 1, a side facing an observer (user) who performs observation using the microscope body 1 is referred to as a front side of the microscope body 1, a side opposite to the side facing the observer is referred to as a rear side of the microscope body 1, a right side as viewed from the observer is simply referred to as a right side, and a left side as viewed from the observer is simply referred to as a left side. The definitions of these directions are for convenience of description of the embodiment, and do not limit the present invention.

An opening 100b is formed in an upper portion of the base housing 100. An upper surface lid 101 for opening and closing the opening 100b is provided in the upper portion of the base housing 100. The rear side of the upper surface lid 101 is connected to the upper portion of the base housing 100 via a shaft 100a extending in the left-right direction. As indicated by a virtual line, the opening 100b of the base housing 100 can be opened by rotating the upper surface lid 101 upward around the shaft 100a. On the other hand, by closing the opening 100b of the base housing 100 as indicated by the solid line, the inside of the base housing 100 can be made a dark room. The fluorescence microscope A is often installed in a dark room in order to suppress the influence of disturbance light such as illumination light. With the above configuration, by forming the dark room space inside the base housing 100, fluorescence observation can be realized even if the fluorescence microscope A is installed in a normal illumination environment, and it is not necessary to install the fluorescence microscope A in the dark room.

The base housing 100 of the microscope body 1 includes an upper frame 102, a stage frame 103, and a lower frame 104. The upper frame 102 is provided in an upper portion inside the base housing 100. The stage frame 103 is provided below the upper frame 102 inside the base housing 100. The lower frame 104 is provided below the stage frame 103 inside the base housing 100. The upper frame 102, the stage frame 103, and the lower frame 104 extend horizontally and are in parallel positional relationship with each other. Openings 103a and 104a through which light used for observation of the observation target B passes are formed in the stage frame 103 and the lower frame 104, respectively. The opening 103a of the stage frame 103 and the opening 104a of the lower frame 104 are formed such that their centers are located on the same straight line extending in an up and down direction.

The microscope body 1 includes a stage S on which the observation target B is placed. The stage S is accommodated in the base housing 100 and is placed on the upper surface of the stage frame 103. The stage S also has an opening S1 through which light used for observation of the observation target B passes. The opening S1 of the stage S is disposed so as to overlap the opening 103a of the stage frame 103 in plan view. Moreover, an XY driving device 105 that drives the stage S in an X direction and a Y direction orthogonal to each other is attached to the upper surface of the stage frame 103. The X direction is the left-right direction, and the Y direction is the front-rear direction. That is, the XY driving device 105 is a device for moving the stage S in a horizontal direction.

The microscope body 1 includes an illumination module 110 that irradiates the observation target B placed on the stage S with excitation light. The illumination module 110 is accommodated in the base housing 100 and attached to the lower frame 104. In the present embodiment, the illumination module 110 is provided behind the optical module 120 described later. Note that the illumination module 110 may be provided below the optical module 120.

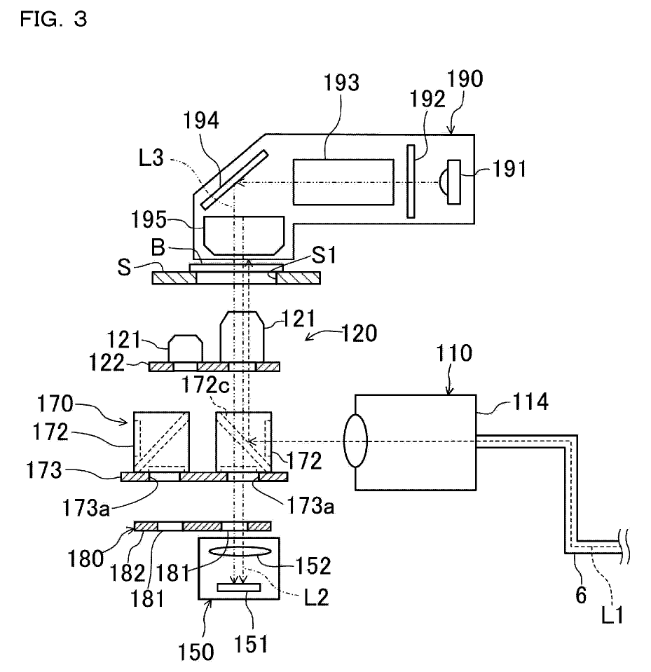

As illustrated in FIG. 3, the other end (the end on the side from which the excitation light is emitted) of the fiber cable 6 is connected to the rear side of the illumination module 110. In FIG. 3, a broken line L1 indicates an optical path of the excitation light.

The illumination module 110 is an excitation illumination section that irradiates the observation target B placed on the stage S with excitation light for fluorescence observation, and includes a module case 114. The other end portion of the fiber cable 6 is connected to the lower portion on the rear side of the module case 114. Furthermore, an optical modulation element that modulates the excitation light emitted from the fiber cable 6 may be provided in the module case 114.

The excitation light emitted from the module case 114 is emitted forward from the front side of the module case 114. The optical path of the excitation light emitted from the module case 114 is along the X direction.

The microscope body 1 includes an optical module 120, a Z-plate 130, and a Z-drive module 140. The optical module 120, the Z-plate 130, and the Z-drive module 140 are accommodated in the base housing 100. The optical module 120 is disposed on the optical path L1 of the excitation light emitted from the illumination module 110, collects the excitation light emitted from the illumination module 110, guides the excitation light to the observation target B, and collects the fluorescence generated in the observation target B. In FIG. 3, an optical path of fluorescence generated in the observation target B is indicated by a one-dot chain line L2. The optical module 120 is provided in front of the illumination module 110.

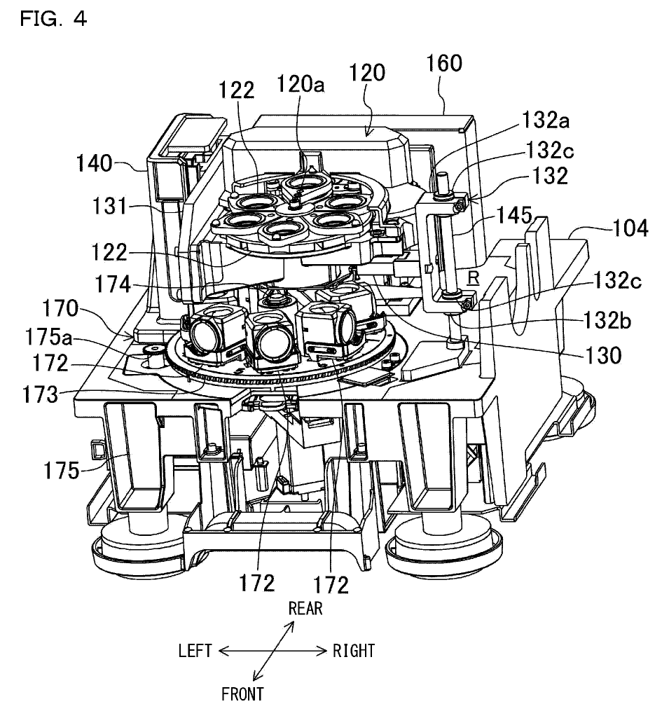

The Z-plate 130 is a member connected to the optical module 120, is provided between the stage frame 103 and the lower frame 104, and extends along the XY plane. As illustrated in FIG. 4, the Z-plate 130 includes a protrusion 131 extending rearward of the optical module 120. The protrusion 131 is provided on the left side of the Z-plate 130.

As illustrated in FIG. 2, the optical module 120 includes a plurality of objective lenses 121, a revolver 122, and a revolver drive device 123. The number of the objective lenses 121 is not particularly limited, and may be any number. The objective lens 121 is disposed below the stage S, and is a member for collecting fluorescence generated from the observation target B by being irradiated with excitation light from the illumination module 110 at the time of fluorescence observation. Furthermore, at the time of transmission observation, the objective lens 121 collects the transmitted light emitted from the transmitted illumination section 190 to be described later and transmitted through the observation target B. The optical axis of each objective lens 121 is along the Z direction.

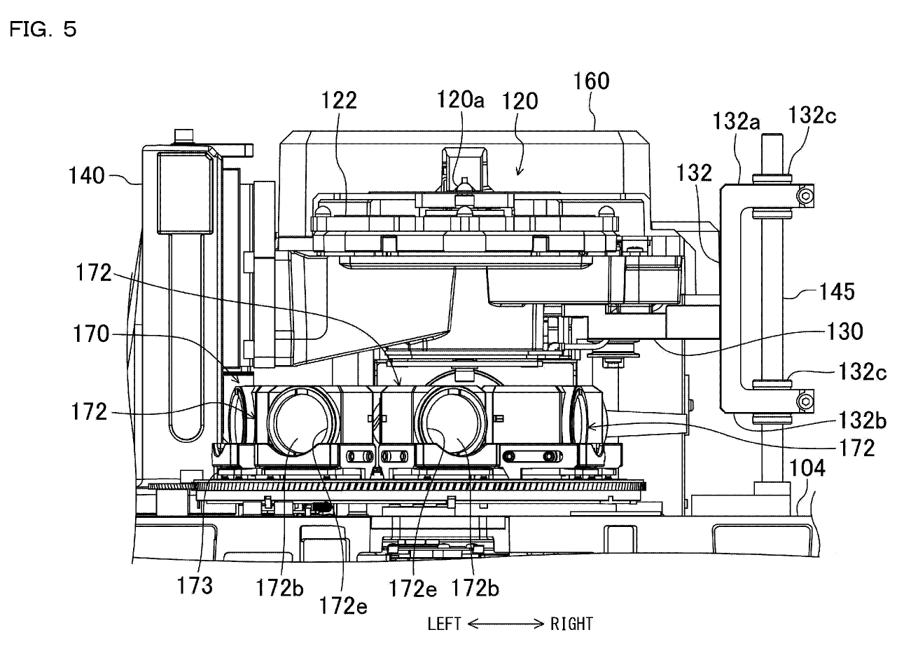

The revolver 122 is provided on the Z-plate 130, and is supported by the Z-plate 130 so as to be rotatable about a revolver shaft (first rotation shaft) 120a (also illustrated in FIGS. 4 and 5) extending in the vertical direction (Z direction). The plurality of objective lenses 121 is detachably attached to the revolver 122 in a state of being disposed so as to surround the revolver shaft 120a.

The revolver drive device 123 is attached to the upper surface of the Z-plate 130. By rotating the revolver 122 around the revolver shaft 120a by the revolver drive device 123, a desired one objective lens 121 among the plurality of objective lenses 121 is disposed immediately below the opening 103a of the stage frame 103, and the optical axis of the objective lens 121 is disposed on the optical path L2 of the fluorescence generated in the observation target B and the optical path L3 of the transmitted light. In this manner, the objective lens 121 used for observation can be switched by the revolver drive device 123. That is, the revolver 122 is a member in which the plurality of objective lenses 121 is disposed to be rotatable about the revolver shaft 120a and that switches the objective lens 121 disposed on the observation optical path.

As illustrated in FIG. 4, the Z-drive module 140 is provided on the left side and the rear side of the lower frame 104. A lower portion of the Z-drive module 140 is attached to the upper surface of the lower frame 104, and the Z-drive module 140 has a shape protruding upward from the upper surface of the lower frame 104.

The protrusion 131 of the Z-plate 130 is positioned on the right side of the Z-drive module 140. The Z-drive module 140 is connected to the protrusion 131 of the Z-plate 130, and moves the objective lens 121, the revolver 122, and the revolver drive device 123 of the optical module 120 connected to the Z-plate 130 in the Z direction. The Z-drive module 140 includes an electric adjustment mechanism 141 (schematically illustrated in FIG. 2). By driving the Z-plate 130 in the Z direction by the electric adjustment mechanism 141, the relative distance in the Z direction between the objective lens 121 used for observation and the observation target B is adjusted.

As also illustrated in FIG. 5, the microscope body 1 includes a support portion 145 that supports the right side of the Z-plate 130 and guides the movement of the optical module 120 in the Z direction. A guide direction of the Z-plate 130 by the support portion 145 is parallel to the Z direction. That is, the support portion 145 is formed of a bar-shaped member extending in the up and down direction. As illustrated in FIG. 4, the lower end portion of the support portion 145 is attached to the right side and the front side portion of the lower frame 104, and the support portion 145 is disposed so as to protrude upward from the upper surface of the lower frame 104. In this manner, by supporting at least two places separated in the left-right direction of the Z-plate 130 by the Z-drive module 140 and the support portion 145, rigidity becomes higher than that of a cantilever support structure using only the Z-drive module 140, and vibration of the Z-plate 130 is reduced.

A supported portion 132 is provided on the right side of the Z-plate 130. The supported portion 132 includes an upper arm portion 132a extending upward from the right side of the Z-plate 130 and a lower arm portion 132b extending downward from the right side of the Z-plate 130. Therefore, since at least two places separated in the up and down direction can be supported by the support portion 145, the Z-plate 130 is further stabilized and hardly vibrates.

The support rigidity on the right side of the Z-plate 130 by the support portion 145 is set to be lower than the support rigidity on the left side of the Z-plate 130 by the Z-drive module 140. Specifically, the upper arm portion 132a and the lower arm portion 132b are each provided with a linear bush 132c, and the support portion 145 is inserted into each linear bush 132c. Each linear bush 132c is a member that guides the right side of the Z-plate 130 in the up and down direction by sliding on the outer peripheral surface of the support portion 145 in the up and down direction. By providing the linear bush 132c, the support rigidity on the right side of the Z-plate 130 by the support portion 145 can be made relatively lower than that on the left side. Since the linear bush 132c is provided, for example, a component manufacturing error can be absorbed by the linear bush 132c, and the movement of the Z-plate 130 in the Z direction can be made smooth. Note that a guide mechanism (for example, a linear guide) other than the linear bush may be used. Furthermore, as a structure for absorbing a manufacturing error of a component, for example, the supported portion 132 may be formed separately from the Z-plate 130, and the position of the supported portion 132 with respect to the Z-plate 130 may be adjusted. Therefore, for example, a manufacturing error of the component can be absorbed at the time of manufacturing, and the movement of the Z-plate 130 in the Z direction can be made smooth. Note that, in the present embodiment, the Z-drive module 140 is provided on the left side and the support portion 145 is provided on the right side, but the positional relationship between the Z-drive module 140 and the support portion 145 may be reversed in the left-right direction. Furthermore, two or more support portions 145 may be provided.

In the present embodiment, another component (not illustrated) can be disposed at the center in the front-rear direction on the right side of the base housing 100. Another component is disposed above lower frame 104. Therefore, it is necessary to form a space R (illustrated in FIG. 4) at the center in the front-rear direction on the right side above the lower frame 104. The support portion 145 is provided on the front side of the space R. Note that, in a case where the space R does not need to be formed, the support portion 145 may be provided at the center in the front-rear direction.

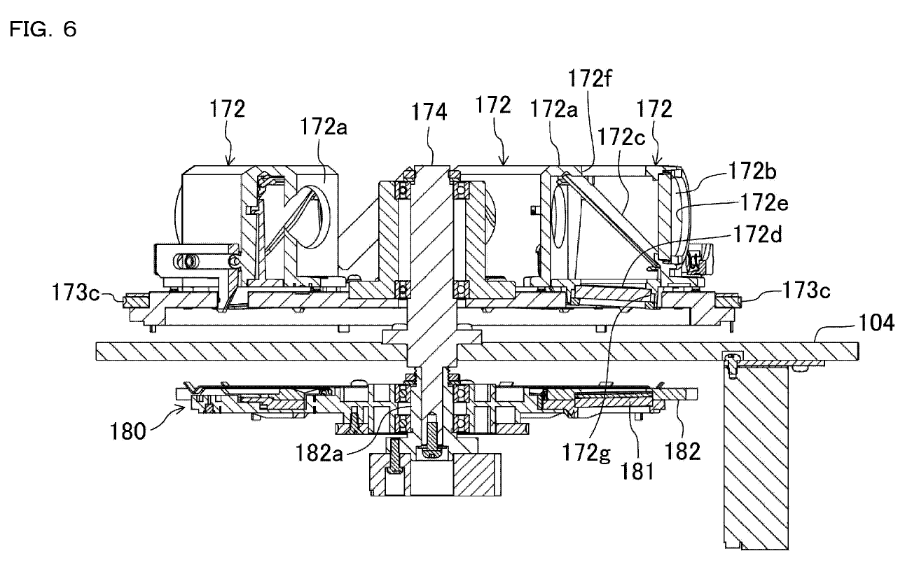

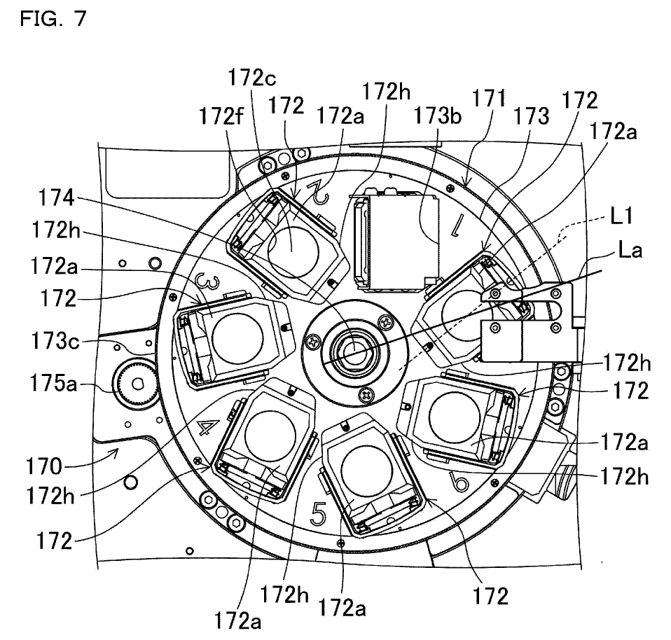

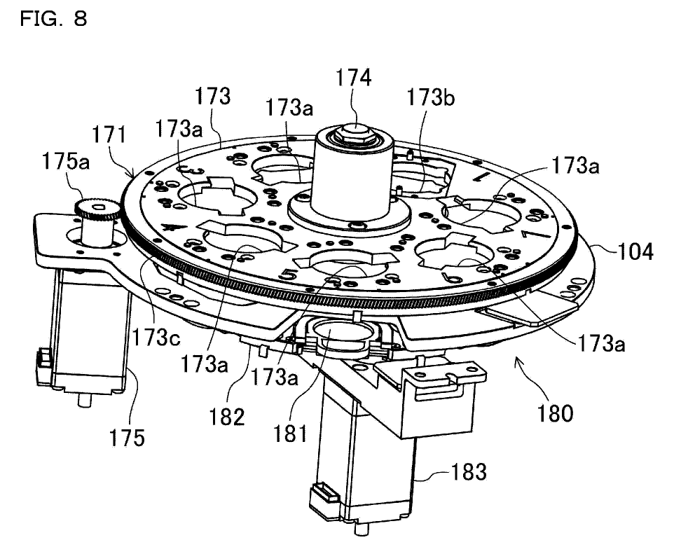

The microscope body 1 includes a filter unit 170 housed in a base housing 100. The filter unit 170 is disposed below the revolver 122 and includes a filter switching device 171 and a plurality of filter cubes 172 as illustrated in FIGS. 6 and 7. The filter switching device 171 includes a filter turret 173 to which a plurality of filter cubes 172 is detachably attached, a support shaft (second rotation shaft) 174 that supports the filter turret 173, and a turret drive motor 175 (illustrated in FIG. 8).

As illustrated in FIG. 6, the support shaft 174 extends in the vertical direction (up and down direction). A portion intermediate in the up and down direction of the support shaft 174 is attached to the lower frame 104. The upper portion of the support shaft 174 protrudes upward from the upper surface of the lower frame 104. A central portion of the filter turret 173 is supported on an upper portion of the support shaft 174 so as to be relatively rotatable.

The support shaft 174 is provided at a position offset in the X direction with respect to the optical axis of the objective lens 121 and the central portion of the revolver 122 in plan view. Specifically, the support shaft 174 is positioned leftward from the optical axis of the objective lens 121 and the revolver shaft 120a. Furthermore, the support shaft 174 may be provided at a position offset in the Y direction with respect to the optical axis of the objective lens 121 and the central portion of the revolver 122 in plan view. Specifically, the support shaft 174 is positioned behind the optical axis of the objective lens 121 and the revolver shaft 120a. With such a configuration, the central portion of the revolver 122 and the central portion of the filter turret 173 are disposed so as not to overlap each other in plan view.

As illustrated in FIGS. 7 and 8, the filter turret 173 has a disk shape. In the filter turret 173, a plurality of through holes 173a and 173b penetrating in the up and down direction is formed at intervals in a circumferential direction of the support shaft 174. The intervals between the through holes 173a and 173b in the circumferential direction are equal. In this embodiment, the seven through holes 173a and 173b are formed, and the filter cube 172 can be attached to the six through holes 173a among them, while the filter cube 172 cannot be attached to one through hole 173b.

The through hole 173b formed in the filter turret 173 is a hole for passing light transmitted through the observation target B at the time of transmission observation. At the time of transmission observation, the filter turret 173 is rotated such that the through hole 173b is disposed on the optical path L3 of the light transmitted through the observation target B. In this manner, by rotating the filter turret 173, it is possible to switch between a state (inserted state) in which the filter cube 172 and the absorption filter 172d included in the filter cube 172 are disposed on the observation optical path and a state (removed state) in which the filter cube 172 and the absorption filter 172d included in the filter cube 172 are not disposed. That is, the filter turret 173 is a member that inserts and removes the filter cube 172 and the absorption filter 172d included in the filter cube 172 on the observation optical path.

A large number of driven teeth 173c are provided in the circumferential direction on the outer peripheral portion of the filter turret 173. The turret drive motor 175 is provided with a pinion gear 175a that meshes with the driven teeth 173c. When the turret drive motor 175 is activated to rotate the pinion gear 175a, the filter turret 173 can be rotated about the support shaft 174. The rotation angle of the filter turret 173 can be any rotation angle by controlling the turret drive motor 175.

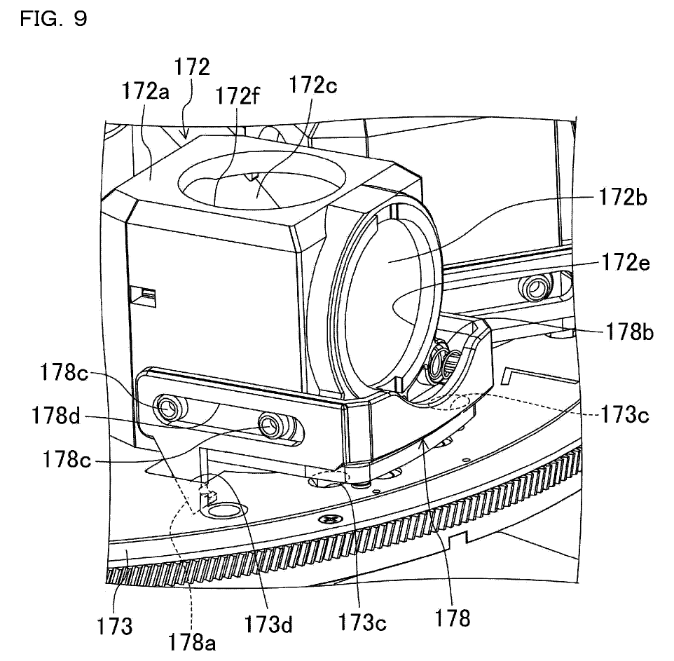

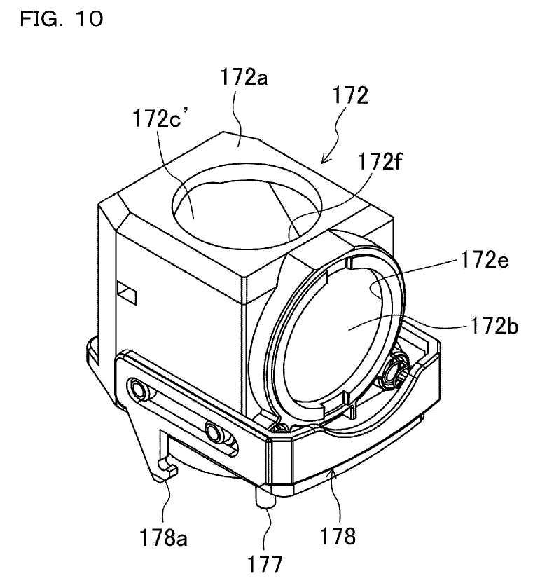

As illustrated in FIGS. 9 to 11, each filter cube 172 includes a frame 172a having an aerial structure, an excitation filter 172b, a dichroic mirror 172c, and an absorption filter 172d. The frame 172a is a cubic member that supports the excitation filter 172b, the dichroic mirror 172c, and the absorption filter 172d. Since each filter cube 172 is disposed below the revolver 122, the excitation filter 172b, the dichroic mirror 172c, and the absorption filter 172d are also disposed below the revolver 122. Since a plurality of the filter cubes 172 is provided, a plurality of excitation filters 172b, a plurality of the dichroic mirrors 172c, and a plurality of the absorption filters 172d are also provided corresponding to the number of filter cubes 172.

The frame 172a includes an entrance window 172e through which the excitation light from the illumination module 110 is incident, an upper emission window 172f through which the excitation light is emitted, and a lower emission window 172g through which the fluorescence generated in the observation target B is emitted. The entrance window 172e is formed on a side surface of the frame 172a, and an excitation filter 172b is provided in the entrance window 172e. The upper emission window 172f is formed on the upper surface of the frame 172a. The lower emission window 172g is formed on the lower surface of the frame 172a, that is, a surface opposed to the surface in the up and down direction on which the upper emission window 172f is formed. The absorption filter 172d is provided in the lower emission window 172g. The absorption filter 172d is an optical member that selectively transmits fluorescence in a predetermined wavelength band among fluorescence collected by the objective lens 121 at the time of fluorescence observation.

A multi-dichroic mirror 172c’ that transmits fluorescence in a plurality of wavelength bands may be provided as the dichroic mirror 172c inside the frame 172a. The dichroic mirror 172c is fixed to the frame 172a in a state of being inclined by a predetermined angle with respect to the Z direction. The excitation light transmitted through the excitation filter 172b provided in the entrance window 172e is reflected upward by the dichroic mirror 172c, passes through the upper emission window 172f, and is emitted upward from the frame 172a. The excitation light having passed through the upper emission window 172f passes through the objective lens 121 and is applied to the observation target B on the stage S.

Since the plurality of filter cubes 172 is attached to the filter turret 173, by rotating the filter turret 173, the filter cube 172 used at the time of fluorescence observation can be switched to arbitrary one filter cube 172 among the plurality of filter cubes 172. The filter turret 173 is a member in which the plurality of excitation filters 172b, the plurality of dichroic mirrors 172c, and the plurality of absorption filters 172d are rotatably disposed about the support shaft 174 extending in the vertical direction and that switches the excitation filters 172b, the dichroic mirrors 172c, and the absorption filters 172d disposed on the observation optical path.

One set is formed by the excitation filter 172b, the dichroic mirror 172c, and the absorption filter 172d provided in one filter cube 172. The excitation filter 172b, the dichroic mirror 172c, and the absorption filter 172d provided in each filter cube 172 are different so as to correspond to the fluorescent reagent used at the time of fluorescence observation. In a case where, for example, GFP, TexasRed, DAPI, or the like is used as the fluorescent reagent, the filter cube 172 corresponding to GFP, TexasRed, DAPI, or the like is attached to the filter turret 173.

The excitation filter 172b of the filter cube 172 corresponding to the GFP allows light having a wavelength of around 490 nm to pass therethrough, and the absorption filter 172d allows light having a wavelength of around 510 nm to pass therethrough. The dichroic mirror 172c reflects light having a wavelength of around 490 nm and allows light having a wavelength of around 510 nm to pass therethrough.

Furthermore, the excitation filter 172b of the filter cube 172 corresponding to the TexasRed allows light having a wavelength of around 596 nm to pass therethrough, and the absorption filter 172d allows light having a wavelength of around 620 nm to pass therethrough. The dichroic mirror 172c reflects light having a wavelength of around 596 nm and allows light having a wavelength of around 620 nm to pass therethrough.

Furthermore, the excitation filter 172b of the filter cube 172 corresponding to the DAPI allows light having a wavelength of around 345 nm to pass therethrough, and the absorption filter 172d allows light having a wavelength of around 455 nm to pass therethrough. The dichroic mirror 172c reflects light having a wavelength of around 345 nm and allows light having a wavelength of around 455 nm to pass therethrough.

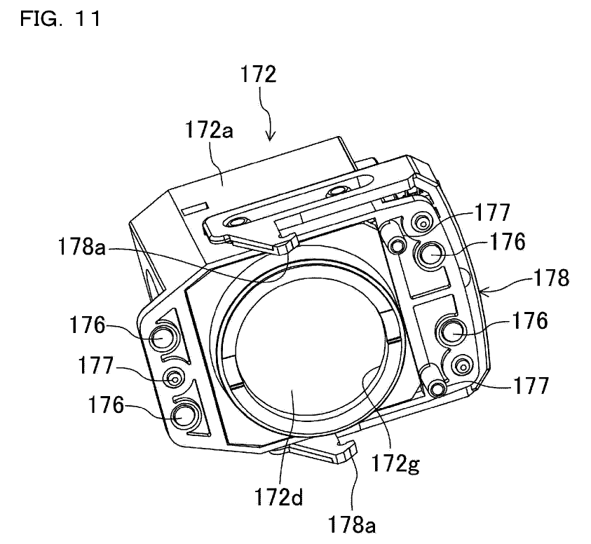

As illustrated in FIG. 11, on a contact surface (lower surface) of the filter cube 172 with the filter turret 173, a fixing portion 176 that fixes the filter cube 172 by attracting the filter turret 173, a positioning portion 177 that positions the filter cube 172 and the filter turret 173, and a locking portion 178a that can be locked to the filter turret 173 are provided.

The fixing portion 176 is formed of a permanent magnet attracted to the upper surface of the filter turret 173. That is, in the upper surface of the filter turret 173, at least a portion to which the fixing portion 176 is fixed is made of a magnetic material, and a permanent magnet having a polarity attracted to the portion made of the magnetic material is the fixing portion 176. Note that the fixing portion 176 may be made of a magnetic material, and a permanent magnet may be provided on the upper surface of the filter turret 173. Furthermore, a permanent magnet having magnetism that attracts the upper surfaces of the fixing portion 176 and the filter turret 173 to each other may be used.

A plurality of the fixing portions 176 is provided on the frame 172a. Specifically, the four fixing portions 176 are provided near the four corners of the lower surface of the frame 172a. The lower emission window 172g is disposed in a region surrounded by the four fixing portions 176. As described above, since a plurality of portions of the filter cube 172 away from each other can be fixed to the filter turret 173, the filter cube 172 can be stabilized on the filter turret 173. Note that the number of the fixing portions 176 is not limited to four, and may be one, or may be any number of three or less or five or more.

The positioning portion 177 is formed of a positioning pin protruding from the lower surface of the frame 172a. The positioning portions 177 are provided at two locations on the lower surface of the frame 172a on a side of the entrance window 172e. On the other hand, as only partially illustrated in FIG. 9, the filter turret 173 is provided with a first receiving portion 173c that receives the positioning portion 177. Since the positioning portions 177 are positioning pins, the first receiving portion 173c is configured by a hole into which the positioning portion 177 can be inserted (received). The hole constituting the first receiving portion 173c is opened on the upper surface of the filter turret 173. Since the two positioning portions 177 are provided, two first receiving portions 173c are also provided. Note that the number of the positioning portions 177 and the first receiving portions 173c is not limited to two, and may be one or any number of three or more.

The locking portion 178a is formed of a fall prevention hook that prevents the filter cube 172 from falling off from the filter turret 173 due to, for example, drop impact during transportation. That is, a slide member 178 is provided in the lower portion of the frame 172a. On a side surface of the slide member 178, a slit 178d into which a holding pin 178c provided on the frame 172a is inserted is formed. The holding pin 178c is relatively movable in the slit 178d, whereby the slide member 178 slides in the same direction as the opening direction of the entrance window 172e. The slide member 178 is constantly urged in a direction away from the entrance window 172e by a biasing member 178b.

As illustrated in FIG. 11, the locking portion 178a protrudes downward from both side portions of the slide member 178. The lower end portion of the locking portion 178a is positioned below the lower surface of the frame 172a. On the other hand, as illustrated in FIG. 9, the filter turret 173 is provided with a second receiving portion 173d that receives the locking portion 178a. Since the locking portion 178a is a hook protruding downward, the second receiving portion 173d is formed of a hole into which the locking portion 178a can be inserted (received). The hole constituting the second receiving portion 173d is opened on the upper surface of the filter turret 173. Since two locking portions 178a are provided, two second receiving portions 173d are also provided. Note that the number of the locking portions 178a and the second receiving portions 173d is not limited to two, and may be one or any number of three or more.

When the locking portion 178a is inserted into the second receiving portion 173d, the slide member 178 is slid in the direction opposite to the biasing direction by the biasing member 178b. Therefore, the locking portion 178a can be inserted into the second receiving portion 173d, and after the insertion, the lower end portion of the locking portion 178a protrudes downward from the lower surface of the filter turret 173 as illustrated in FIG. 9.

The positioning portion 177 is disposed such that the locking portion 178a and the filter turret 173 are in a non-contact state in a state where the locking portion 178a of the filter cube 172 is received by the second receiving portion 173d. That is, when the positioning portion 177 is received by the first receiving portion 173c, the position in the X direction and the position in the Y direction of the filter cube 172 on the filter turret 173 are decided. In a state where the position in the X direction and the position in the Y direction are decided, the locking portion 178a is received by the second receiving portion 173d, and at this time, the locking portion 178a is separated from the inner surface of the second receiving portion 173d and the lower surface of the filter turret 173. Therefore, the locking portion 178a does not interfere with the filter turret 173. On the other hand, when the filter cube 172 is about to be detached from the filter turret 173 due to, for example, drop impact or the like, the locking portion 178a is caught on the inner surface of the second receiving portion 173d or the lower surface of the filter turret 173, so that the filter cube 172 is prevented from falling off in advance.

As described above, the plurality of filter cubes 172 is detachably attached to the upper surface of the filter turret 173. The attitude of the filter cube 172 on the filter turret 173 can be set to a desired attitude by the positions of the fixing portion 176, the positioning portion 177, the locking portion 178a, and the first receiving portion 173c and the second receiving portion 173d. FIG. 7 is a view of a state in which the plurality of filter cubes 172 is attached to the upper surface of the filter turret 173 as viewed from above. As illustrated in this drawing, when viewed along the support shaft 174, that is, when the support shaft 174 is viewed from above, the attitude of the filter cube 172 on the filter turret 173 is set such that an optical path L1 of the excitation light incident on the entrance window 172e forms a predetermined angle α with respect to the straight line La connecting the center of the support shaft 174 and the center of the filter cube 172. The angle α can be, for example, in a range of 5° or more and 30° or less. By disposing the plurality of filter cubes 172 in the above-described attitude, it is possible to narrow the interval in the circumferential direction of the plurality of filter cubes 172 and to suppress an increase in the outer diameter of the filter turret 173.

Furthermore, when viewed along the support shaft 174, the corners of the frame 172a of the filter cube 172 are partially dropped, whereby a chamfered portion 172h is formed in the frame 172a. Since the optical components (excitation filter 172b, dichroic mirror 172c, and absorption filter 172d) are not originally disposed in the portion where the chamfered portion 172h is formed, deterioration in optical performance due to the formation of the chamfered portion 172h does not occur. That is, by forming the chamfered portion 172h by cutting the dead space in the frame 172a, the interval in the circumferential direction of the plurality of filter cubes 172 can be further narrowed.

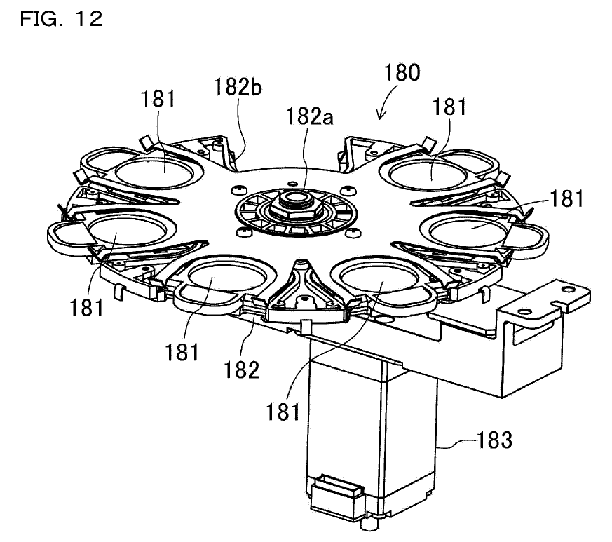

An emission filter unit 180 as illustrated in FIG. 12 is provided below the filter turret 173, that is, below the dichroic mirror 172c. The emission filter unit 180 includes a plurality of emission filters 181, a filter wheel 182 to which the plurality of emission filters 181 is detachably attached, and a wheel drive motor 183. Although not illustrated, the wheel drive motor 183 transmits a rotational force to the filter wheel 182 via, for example, a gear.

The plurality of emission filters 181 is disposed at intervals in the circumferential direction of the filter wheel 182. By rotating the filter wheel 182, arbitrary one emission filter 181 of the plurality of emission filters 181 can be disposed on an optical path L2 of fluorescence. The filter wheel 182 is provided with a notch 182b to which the emission filter 181 is not attached. The notch 182b is a part through which the light transmitted through the observation target B passes at the time of transmission observation, and the filter wheel 182 is rotated so that the notch 182b is disposed on an optical path L3 of the light transmitted through the observation target B at the time of transmission observation.

The emission filter 181 is a member for selectively transmitting fluorescence in a specific wavelength band. That is, the plurality of emission filters 181 functions as a multi-filter that transmits fluorescence in a plurality of wavelength bands by sequentially switching the absorption filters disposed on the optical path L2 of fluorescence. For example, the wavelength band of the received fluorescence can be changed by fixing the filter turret 173 in which the multi-band dichroic mirror 172c that transmits fluorescence of a plurality of wavelength bands is disposed and rotating the filter wheel 182 to sequentially switch the emission filter 181. Since the emission filter 181 has a low accuracy requirement on the reflective surface like the filter cube 172, the accuracy at the time of movement may be lower than that of the filter cube 172, so that it can be switched faster than the filter cube 172.

As illustrated in FIG. 6, the filter wheel 182 is disposed below the lower frame 104. A cylindrical member 182a supported by the support shaft 174 is provided at a central portion of the filter wheel 182. In a state where the lower portion of the support shaft 174 is inserted into the cylindrical member 182a, the cylindrical member 182a becomes relatively rotatable with respect to the support shaft 174. As described above, the rotation shafts of the emission filter 181 attached to the filter wheel 182 and the filter turret 173 are both the support shaft 174 and are common.

When the emission filter 181 is provided, a distance between the objective lens 121 and an imaging lens 152 to be described later is increased, and thus there is a concern about image quality degradation such as shading. On the other hand, in the present embodiment, the rotation shafts of the filter wheel 182 and the filter turret 173 are made common (coaxial) to achieve compactness, so that the distance between the objective lens 121 and the imaging lens 152 can be reduced as much as possible. Therefore, it is possible to realize downsizing of the microscope body 1 in a height direction while suppressing image quality degradation.

As illustrated in FIG. 2, the microscope body 1 includes a transmitted illumination section 190. The transmitted illumination section 190 includes a transmitted light source 191, a diaphragm adjustment section 192, and a transmission optical system 193. The transmitted light source 191 includes, for example, a white LED or the like. The transmitted light source 191 may include another light source such as a halogen lamp, for example. The transmitted light source 191 is used as a light source for performing transmission observation of the observation target B. Hereinafter, the light emitted from the transmitted light source 191 is referred to as transmitted light. The diaphragm adjustment section 192 includes a diaphragm and a phase difference slit, and is used to adjust the brightness of the transmitted light with which the observation target B is irradiated and to perform phase difference observation with the transmitted light. The transmission optical system 193 includes a relay lens. The transmission optical system 193 is configured to guide the transmitted light emitted from the transmitted light source 191 forward.

The transmitted light guided forward is reflected downward by the mirror 194, passes through a condenser lens 195, and is transmitted through the observation target B on the stage S. The relay lens included in the transmission optical system 193 is disposed such that a conjugate relationship is maintained between the diaphragm and the phase difference slit included in the diaphragm adjustment section 192 and a front focal position of the condenser lens 195. An optical path of the transmitted light is indicated by reference sign L3.

The optical path L3 of the transmitted light partially overlaps with the optical path L1 of the excitation light. That is, the excitation light is emitted from below to above the stage S. A part of the excitation light transmitted through the observation target B is incident on the condenser lens 195 of the transmitted illumination section 190. The excitation light incident on the condenser lens 195 may be reflected by the mirror 194, transmitted through the transmission optical system 193 and the diaphragm adjustment section 192, and reach the transmitted light source 191. That is, the transmitted light source 191 of the transmitted illumination section 190 is disposed on the optical path of the excitation light transmitted through the observation target B.

The microscope body 1 includes an imaging module 150. The imaging module 150 is accommodated in the base housing 100 and is provided below the lower frame 104. The imaging module 150 is disposed on the optical path L2 of the fluorescence collected by the optical module 120 and detects the fluorescence collected by the optical module 120, and is disposed on the optical path L3 of the light transmitted through the observation target B and detects the light transmitted through the observation target B. In the present embodiment, the imaging module 150 is provided below the optical module 120.

The imaging module 150 includes a camera 151 and an imaging lens 152. The camera 151 is, for example, a complementary metal oxide semiconductor (CMOS) image sensor including an imaging element. The imaging element is, for example, a monochrome CMOS, and the camera 151 includes a monochrome camera including a monochrome CMOS. The imaging element may be another imaging element such as a charge coupled device (CCD) image sensor.

Fluorescence or transmitted light incident on the imaging module 150 is collected and imaged by the imaging lens 152, and then received by the camera 151. Therefore, an image of the observation target B is obtained. An analog electric signal (Hereinafter, referred to as a light reception signal.) corresponding to the amount of received light is output from each pixel of the imaging element of the camera 151 to a control board 160.

Unlike the color CCD, the monochrome CCD constituting the camera 151 of the present embodiment does not need to be provided with a pixel that receives light of a red wavelength, a pixel that receives light of a green wavelength, and a pixel that receives light of a blue wavelength. Therefore, the measurement resolution of the monochrome CCD is higher than the resolution of the color CCD. Furthermore, unlike the color CCD, the monochrome CCD does not need to include a color filter in each pixel. Therefore, the sensitivity of the monochrome CCD is higher than the sensitivity of the color CCD. For these reasons, the camera 151 according to the present embodiment includes a monochrome CCD. Note that, in a case where the color CCD has sufficient resolution and sensitivity, the imaging element may be a color CCD.

An analog/digital converter (A/D converter), a first in first out (FIFO) memory, and the like (not illustrated) are mounted on the control board 160. The light reception signal output from the camera 151 is sampled at a constant sampling period by the A/D converter and converted into a digital signal on the basis of the control of the electronic computer 2 illustrated in FIG. 1. The digital signals output from the A/D converter are sequentially accumulated in the FIFO memory. The digital signals accumulated in the FIFO memory are sequentially transferred to the electronic computer 2 as pixel data.

As illustrated in FIG. 1, the electronic computer 2 includes, for example, a desktop personal computer or a notebook personal computer, and includes a computer body 20, a display section 21, and an operation section 22. The computer body 20 includes a central processing unit (CPU), a read only memory (ROM), a random access memory (RAM), a storage device, and the like. The ROM stores a system program. The RAM stores various data and functions as a work region of the CPU. The storage device includes a solid state drive, a hard disk drive, or the like. The storage device stores a control program and an image processing program of the fluorescence microscope A. On the basis of the control program and the image processing program, the computer body 20 controls each part of the microscope body 1 and controls the light source unit 3. Furthermore, the storage device is also used to store various data such as image data output from the imaging module 150.

The display section 21 includes, for example, an LCD panel, an organic electroluminescence (EL) panel, or the like. On the display section 21, a user interface screen for performing various settings of the fluorescence microscope A is displayed, and an observation image or the like based on the image data output from the imaging module 150 is displayed.

The operation section 22 includes a member for operating the computer body 20. Examples of the member constituting the operation section 22 include a keyboard and a pointing device. Examples of the pointing device include a mouse and a joystick.

The computer body 20 controls each part of the microscope body 1, so that fluorescence observation using fluorescence can be performed and transmission observation can also be performed. At the time of fluorescence observation, the filter switching device 171 operates and switches to the filter cube 172 corresponding to the fluorescent reagent to be used. Furthermore, the objective lens is switched to a desired objective lens 121 by the revolver drive device 123. Moreover, in a case where the emission filter 181 is used, the emission filter unit 180 operates and is switched to a desired emission filter 181.

The light source unit 3 can generate excitation light having a desired wavelength. The excitation light generated by the light source unit 3 is transmitted to the microscope body 1 via the fiber cable 6, transmitted through the filter cube 172 and the objective lens 121, and then applied to the observation target B. At the time of observation, the Z-drive module 140 operates, and focus adjustment is automatically executed.

The fluorescence generated in the observation target B is incident on the objective lens 121, then is transmitted through the filter cube 172 and the emission filter 181, and is incident on the imaging module 150. The fluorescence incident on the imaging module 150 is received by the camera 151. The analog electric signal corresponding to the amount of received light is output from the control board 160 to the computer body 20 to generate image data, and the image data is displayed on the display section 21.

At the time of transmission observation, the observation target B is irradiated with the transmitted light emitted from the transmitted illumination section 190. In the transmission observation, the filter switching device 171 operates, and the filter cube 172 is not disposed on the optical path L3 of the transmitted light. Furthermore, the objective lens is switched to a desired objective lens 121 by the revolver drive device 123. Moreover, the emission filter unit 180 operates so that the emission filter 181 is not disposed on the optical path L3 of the transmitted light. Also at the time of transmission observation, the Z-drive module 140 operates, and focus adjustment is automatically executed.

The transmitted light transmitted through the observation target B is incident on the objective lens 121, and then is incident on the imaging module 150 without being transmitted through the filter cube 172 and the emission filter 181. The transmitted light incident on the imaging module 150 is received by the camera 151. The analog electric signal corresponding to the amount of received light is output from the control board 160 to the computer body 20 to generate image data, and the image data is displayed on the display section 21.

The above-described embodiments are merely examples in all respects, and should not be construed in a limiting manner. Moreover, all modifications and changes falling within the equivalent scope of the claims are within the scope of the present invention. For example, the fluorescence microscope A may perform only fluorescence observation.

As described above, the fluorescence microscope according to the present disclosure can be used, for example, in the case of observing a biological specimen or the like.

What is claimed is:

1. A fluorescence microscope comprising:
a stage on which an observation target is placed;
an illumination module configured to irradiate the observation target placed on the stage with excitation light;
an optical module disposed on an optical path of the excitation light emitted from the illumination module, and configured to collect the excitation light emitted from the illumination module and guide the excitation light to the observation target, and collect fluorescence generated in the observation target;
an imaging module disposed on an optical path of the fluorescence collected by the optical module and configured to detect the fluorescence collected by the optical module;
a Z-plate connected to the optical module and including a protrusion extending rearward of the optical module;
a Z-drive module connected to the protrusion of the Z-plate and configured to move the optical module in a Z direction;
a base housing configured to accommodate the stage, the illumination module, the optical module, the imaging module, and the Z-drive module; and
an upper surface lid connected to the base housing and configured to open and close an opening formed in an upper portion of the base housing.

2. The fluorescence microscope according to claim 1, further comprising a support portion configured to support the Z-plate and guide movement of the optical module in the Z direction.

3. The fluorescence microscope according to claim 1, wherein
the optical module is provided in front of the illumination module, and
the imaging module is provided below the optical module.

4. The fluorescence microscope according to claim 1, wherein
the optical module is provided in front of the imaging module, and
the illumination module is provided below the optical module.

5. The fluorescence microscope according to claim 1, wherein
the optical module includes:
a plurality of objective lenses disposed below the stage and configured to collect fluorescence generated from an observation target by being irradiated with excitation light from the illumination module;
a revolver in which the plurality of objective lenses is rotatably disposed about a first rotation shaft extending in a vertical direction, and configured to switch the objective lenses disposed on an observation optical path;
a plurality of absorption filters disposed below the revolver and configured to selectively transmit respective predetermined wavelength band; and
a filter turret in which the plurality of absorption filters is rotatably disposed about a second rotation shaft extending in the vertical direction, and configured to switch the absorption filters disposed on the observation optical path.

6. The fluorescence microscope according to claim 5, wherein the second rotation shaft is provided at a position offset from the first rotation shaft in an X-axis direction and a Y-axis direction.

7. The fluorescence microscope according to claim 5, wherein
a dichroic mirror configured to transmit fluorescence in a plurality of wavelength bands is disposed below the revolver,
a plurality of emission filters configured to selectively transmit fluorescence in a plurality of wavelength bands is further provided below the dichroic mirror, and
the wavelength bands of fluorescence received by the imaging module are sequentially switched by sequentially rotating the emission filter.

8. The fluorescence microscope according to claim 7, wherein rotation shafts of the emission filter and the filter turret are common.

9. The fluorescence microscope of claim 5, wherein each of the absorption filters is disposed in a filter cube including an entrance window through which excitation light from the illumination module enters; and each of the filter cubes is disposed on the filter turret.

10. The fluorescence microscope according to claim 9, wherein
a contact surface of the filter cube with the filter turret is provided with a fixing portion configured to fix the filter cube to the filter turret, a positioning portion configured to position the filter cube and the filter turret, and a locking portion configured to be able to be locked to the filter turret,
the filter turret is provided with a first receiving portion configured to receive the positioning portion and a second receiving portion configured to receive the locking portion, and
the positioning portion is disposed so that the locking portion and the filter turret are in a non-contact state in a state where the locking portion of the filter cube is received by the second receiving portion.

11. The fluorescence microscope according to claim 2, wherein a guide direction of the Z-plate by the support portion is parallel to the Z direction.

12. The fluorescence microscope according to claim 1, further comprising:
an illumination section;
an excitation filter configured to selectively transmit a wavelength of excitation light emitted from the illumination section;
an illumination housing configured to accommodate the illumination section and the excitation filter; and
a transmission member configured to transmit the excitation light transmitted through the excitation filter and emitted from the illumination housing to the base housing.

13. The fluorescence microscope according to claim 9, wherein an attitude of the filter cube on the filter turret is set such that an optical axis of excitation light incident on the entrance window forms a predetermined angle with respect to a straight line connecting the second rotation shaft and a center of the filter cube when viewed along the second rotation shaft.
